(19) United States
(12) Patent Application Publication
(10) Pub. No.: US 2023/0223585 A1
(43) Pub. Date: Jul. 13, 2023

(54) BATTERY AND METHOD OF PRODUCING THE SAME

(71) Applicant: Panasonic Intellectual Property Management Co., Ltd., Osaka (JP)

(72) Inventor: SEIJI NISHIYAMA, Osaka (JP)

(21) Appl. No.: 18/185,401

(22) Filed: Mar. 17, 2023

Related U.S. Application Data
(63) Continuation of application No. PCT/JP2021/031644, filed on Aug. 30, 2021.

(30) Foreign Application Priority Data
Oct. 2, 2020 (JP) 2020-167656
Aug. 17, 2021 (JP) 2021-132756

(51) Int. Cl. H01M 10/052; H01M 4/36; H01M 50/426; H01M 50/502; H01M 10/0562

(52) U.S. Cl. CPC H01M 10/052; H01M 4/366; H01M 50/426; H01M 50/502; H01M 10/0562

(57) ABSTRACT

A battery includes a power generation element including a positive electrode layer, a negative electrode layer, and a solid electrolyte layer located between and in contact with both the positive electrode layer and the negative electrode layer, an outer body accommodating the power generation element, and an adhesive body located between and in contact with both a main surface of the power generation element and the outer body.

### BACKGROUND

### 1. Technical Field

The present disclosure relates to a battery and a method of producing the same.

### 2. Description of the Related Art

Conventional batteries have a problem of displacement of a power generation element relative to the outer body, which occurs when the power generation element is enfolded by the outer bodies such as a lamination film. A known battery (for example, Japanese Unexamined Patent Application Publication No. 2019-164892) includes an adhesive layer to reduce the displacement.

Japanese Unexamined Patent Application Publication No. 2019-164892 discloses a battery including an all-solid-state battery stack that includes at least one all-solid-state unit cell, a positive terminal connected to a positive current collector layer, a negative terminal connected to a negative current collector layer, and an outer body lower member that constitutes an outer body enfolding the all-solid-state battery stack. The battery further includes an adhesive layer at least one of between the positive or negative current collector layer of the all-solid-state battery stack and the outer body lower member and between the positive and negative terminals and the outer body lower member.

### SUMMARY

In conventional batteries, it is difficult to position the power generation element and the outer bodies such as the lamination film, relative to each other. When the positioning is difficult, the power generation element is likely to be displaced in the outer body. The displacement of the power generation element may lower the reliability of the battery.

One non-limiting and exemplary embodiment provides a battery having high reliability and provides a method of producing the same.

In one general aspect, the techniques disclosed here feature a battery including a power generation element including a positive electrode layer, a negative electrode layer, and a solid electrolyte layer located between and in contact with both the positive electrode layer and the negative electrode layer, an outer body accommodating the power generation element, and an adhesive body located between and in contact with both a main surface of the power generation element and the outer body.

The present disclosure can provide a battery having high reliability.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view illustrating a schematic configuration of a battery according to an embodiment;

FIG. 2 is a magnified cross-sectional view of an area II in FIG. 1 including main components;

FIG. 3 is a perspective view illustrating a lower surface of the power generation element and an upper surface of an adhesive body of the battery according to the embodiment to indicate the shapes of them and the positional relationship between them;

FIG. 4 is a plan view illustrating a lower surface of the power generation element and an upper surface of an adhesive body of the battery according to the embodiment to indicate the shapes of them and the positional relationship between them;

FIG. 5 is a plan view illustrating the lower surface of the power generation element and an upper surface of an adhesive body of a modification of the battery according to the embodiment to indicate the shapes of them and the positional relationship between them;

FIG. 6 is a plan view illustrating the lower surface of the power generation element and an upper surface of an adhesive body of another modification of the battery according to the embodiment to indicate the shapes of them and the positional relationship between them;

FIG. 7 is a view schematically illustrating how the outer body is detached from the adhesive body in the battery according to the embodiment;

FIG. 8 is a view schematically illustrating how the adhesive body is detached from the power generation element in the battery according to the embodiment; and

FIG. 9 is a flow chart illustrating steps of producing the battery according to the embodiment.

### DETAILED DESCRIPTIONS

### Underlying Knowledge Forming Basis of the Present Disclosure

The inventors of the present disclosure found that, when the power generation element of the conventional battery is encapsulated in the outer body, the following problems arise.

In the conventional batteries, a volatile substance may volatize from an adhesive of an adhesive layer in the encapsulating step. This may lower the performance of the power generation element. Furthermore, the adhesive may be contracted when cured, and the stress generated by the contraction may warp the power generation element. The warping may lower the reliability of the battery, because the warping may lower the performance of the power generation element, damage the power generation element, or detach and displace the power generation element from the attachment portion.

For example, the displacement of the power generation element is likely to be caused when the pressure in the chamber having the power generation element is returned to an atmospheric pressure in the encapsulating step, which is typically performed in reduced pressure atmosphere such as vacuum. When the displacement is caused, an electrical connection between an electrode terminal of the power generation element and a lead-out electrode that draws the power to a component outside the battery becomes bad, for example. This may lower the reliability of the battery.

The present disclosure was made to solve the above-described problems and provides a battery having high reliability.

A battery according to an aspect of the present disclosure includes a power generation element including a positive electrode layer, a negative electrode layer, and a solid electrolyte layer located between and in contact with both the positive electrode layer and the negative electrode layer, an outer body accommodating the power generation element, and an adhesive body located between and in contact with both a main surface of the power generation element and the outer body.

The adhesive body virtually contains no volatile substance that volatiles in reduced pressure atmosphere, and thus this configuration reduces deterioration of performance of the power generation element resulting from the volatile substance. Furthermore, this configuration does not include an adhesive and thus reduces warping of the power generation element caused by an adhesive. The battery according to this aspect includes an adhesive body instead of an adhesive to fix the power generation element to the outer body. Thus, the adhesive body reduces displacement between the power generation element and the outer body. Furthermore, the adhesive body can protect the power generation element from an external impact. As described above, the present aspect can provide a battery having high reliability.

Furthermore, for example, a peel strength between the adhesive body and the power generation element may be smaller than a peel strength between the layers of the power generation element.

This allows easy detachment of the adhesive body from the power generation element without damage to the power generation element. Thus, the detached adhesive body is reusable for fixation of another power generation element.

Furthermore, for example, a peel strength between the adhesive body and the outer body may be smaller than a peel strength between the layers of the power generation element.

This allows easy detachment of the adhesive body from the outer body. Thus, the detached adhesive body is reusable for fixation of the power generation element to another outer body.

Furthermore, for example, the adhesive body may overlap a center of the main surface when the main surface is viewed in plan view.

The contact of the adhesive body to a center of the power generation element can reduce direction dependency of the anti-displacement effect of the adhesive body. In other words, the adhesive body can reduce the displacement of the power generation element in various directions.

Furthermore, for example, a center of the adhesive body may coincide with a center of the main surface when the main surface is viewed in plan view.

The overlap between a center of the power generation element and a center of the adhesive body can further reduce the direction dependency of the anti-displacement effect of the adhesive body. In other words, the adhesive body can further reduce the displacement of the power generation element in various directions.

Furthermore, for example, the adhesive body may have a point symmetrical shape, a line symmetrical shape, or a rotationally symmetrical shape, when the main surface is viewed in plan view.

This allows the adhesive body to have a balanced symmetrical shape in plan view and does not allow the adhesive body to have an anisotropic shape unevenly elongated in one direction. The attachment surface between the adhesive body and the power generation element that is less unevenly shaped can reduce the direction dependency of the anti-displacement effect of the adhesive body. Thus, displacement of the power generation element can be further reduced.

Furthermore, for example, a contact area between the adhesive body and the main surface may be greater than or equal to 10% and less than 100% of an area of the main surface.

This can provide a large contact area between the adhesive body and the power generation element, and thus displacement of the power generation element can be further reduced.

Furthermore, for example, the battery may further include a positive terminal electrically connected to the positive electrode layer, and a negative terminal electrically connected to the negative electrode layer. Each of the positive terminal and the negative terminal has a bent structure which is in contact with a side surface of the power generation element and the main surface, and the adhesive body may be located with a gap between the positive terminal and the negative terminal.

In this configuration, the positive terminal and the negative terminal are placed along the side surfaces and the main surface of the power generation element, and thus the terminals are less likely to be damaged than terminals that are drawn laterally. Furthermore, the adhesive body and each of the terminals are away from each other. This prevents the adhesive body from pressing the terminals even if the adhesive body is expanded in the encapsulating step, and thus damage to the terminals can be reduced. This configuration can provide a battery having high reliability.

Furthermore, for example, the outer body may include a resin layer in contact with the adhesive body, and a total of a thickness of the adhesive body and a thickness of the resin layer may be equal to each of a thickness of a portion of the positive terminal in contact with the main surface and a thickness of a portion of the negative terminal in contact with the main surface.

This reduces warping of the power generation element and generation of asperities in the surface of the outer body.

Furthermore, for example, the adhesive body may include a rubber material or a gel material. Furthermore, for example, the adhesive body may be formed of at least one selected from the group consisting of a fluoropolymer, fluororubber, silicone rubber, butyl rubber, ethylene propylene rubber, natural rubber, chloroprene rubber, nitrile rubber, polymethyl methacrylate, urethane rubber, and polyethylene terephthalate.

The adhesive body having such a configuration has high distortion resistance and restorability, and thus displacement is further reduced.

Furthermore, for example, the outer body may include a lamination film.

This enables more reliable encapsulating of the power generation element, leading to an increase in the reliability of the battery.

Furthermore, the solid electrolyte layer may be a solid electrolyte layer that conducts lithium ions.

This configuration can provide a battery having high charge and discharge properties and high reliability.

Furthermore, for example, a method of producing a battery according to an aspect of the present disclosure includes providing an outer body, providing a power generation element, placing an adhesive body on the outer body, placing the power generation element to be in contact with the adhesive body, reducing pressure around the outer body, enfolding the power generation element in the outer body in the reduced pressure atmosphere, and exposing the outer body to a normal pressure atmosphere.

This allows the power generation element and the outer body to be fixed to each other without an adhesive, but with the adhesive body, and can reduce displacement between the power generation element and the outer body. The adhesive body virtually contains no volatile substance that volatiles in reduced pressure atmosphere. This reduces deterioration of the performance of the power generation element caused by a volatile substance. Furthermore, this configuration does not include an adhesive and thus reduces warping of the power generation element caused by an adhesive. As described, according to this aspect, a battery having high reliability can be produced.

Furthermore, for example, the placing the power generation element to be in contact with the adhesive body may further include pressing or applying pressure to the power generation element and the adhesive body.

This increases the adhesion strength between the power generation element and the adhesive body, and thus the displacement between the power generation element and the outer body can be further reduced.

Furthermore, the reducing the pressure around the outer body may include pressing or applying pressure to the power generation element and the adhesive body.

This increases the adhesion strength between the power generation element and the adhesive body, and thus the displacement between the power generation element and the outer body can be further reduced.

Furthermore, for example, the exposing the outer body to a normal pressure atmosphere may include pressing or applying pressure to the power generation element and the adhesive body.

This increases the adhesion strength between the power generation element and the adhesive body, and thus the displacement between the power generation element and the outer body can be further reduced.

Furthermore, for example, the outer body may include a lamination film.

This enables more reliable encapsulating of the power generation element, leading to an increase in the reliability of the battery.

Furthermore, for example, the method may further include detaching the adhesive body from the outer body and placing the detached adhesive body onto an outer body different from the outer body.

This enables reuse of the adhesive body. This reduces not only the production cost of the battery but also waste.

Furthermore, for example, a method of producing a battery according to another aspect of the present disclosure includes detaching the adhesive body from the outer body of the battery according to the above-described aspects and placing the detached adhesive body onto an outer body different from the outer body.

This enables reuse of the adhesive body. This reduces not only the production cost of the battery but also waste.

Hereinafter, an embodiment will be described in detail with reference to the drawings.

The embodiment described below is a general or specific example. The numbers, shapes, materials, components, positions and connection of the components, steps, and order of the steps in the following embodiment are examples and are not intended to be limiting of the disclosure. The components of the following embodiment that are not included in an independent claim are explained as optional.

In addition, the drawings are schematic diagrams and are not necessarily strictly to scale. Accordingly, scale sizes, for example, may be different for different diagrams. Furthermore, the same reference numerals are assigned to the components having substantially the same configuration in the drawings without duplicated or detailed explanation.

In addition, terms indicating relationships between components, such as parallel and perpendicular, terms indicating shapes of components, such as rectangular and circular, and numerical ranges in this specification are not strictly limited to the terms and the ranges. The terms and the ranges may include approximation, e.g., variations of a few percentages.

Furthermore, the terms “upper” and “lower” used herein are not meant to refer to the upward direction (vertically upward) and the downward direction (vertically downward) in absolute spatial awareness. The terms are meant to refer to the relative positional relationship based on the stacking order of the stacking structure. Furthermore, the terms “above” and “below” are applicable to not only a case where two components are spaced apart from each other with another component interposed therebetween but also a case where two components are in close contact with each other without another component interposed therebetween.

Furthermore, in the specification and the drawings, the x, y, and z axes are three axes of a three-dimensional orthogonal coordinate system. In the specification, the “main surface” of the power generation element is a surface perpendicular to the stacking direction of the layers of the power generation element. The stacking direction may also be referred to as a thickness direction of the power generation element or the battery. In the following description, the positive side of the z axis is referred to as above or an upper side and the negative side of the z direction is referred to as below or a lower side. Specifically, the surface of the power generation element on the positive side of the z axis is referred to as an “upper surface” and the surface of the power generation element on the negative side of the z axis is referred to as a “lower surface” or a “bottom surface” in some cases.

Furthermore, in this specification, “plan view” means that the main surface of the power generation element is viewed straight in a direction perpendicular to the main surface of the power generation element, or in the stacking direction.

### Embodiment

### 1. Outline

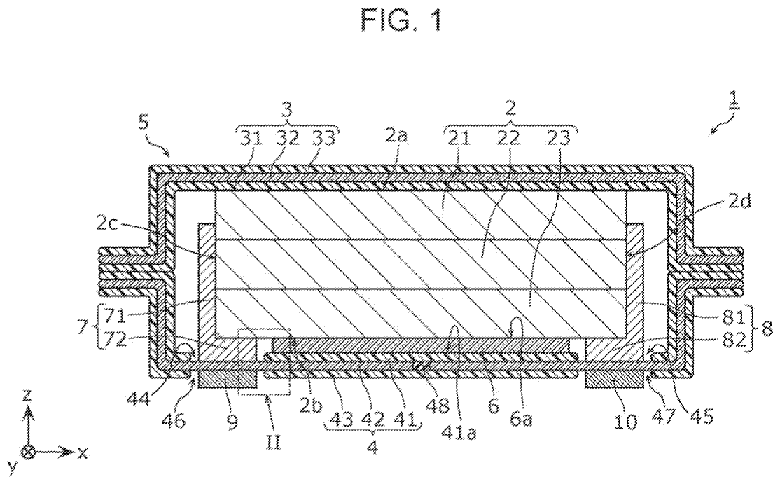

First, an outline of a battery according to an embodiment will be described with reference to FIG. 1. FIG. 1 is a cross-sectional view illustrating a schematic configuration of a battery 1 according to the embodiment.

As illustrated in FIG. 1, the battery 1 includes a power generation element 2, an outer body 5, and an adhesive body 6. In this embodiment, when the outer body 5 encapsulates the power generation element 2, the outer body 5 accommodates and encapsulates the adhesive body 6 together with the power generation element 2. The adhesive body 6 is used to position the power generation element 2 relative to the outer body 5. Specifically, the adhesive body 6 fixes the power generation element 2 and the outer body 5 to each other to reduce displacement of the power generation element 2.

### 2. Configuration

Next, the specific configuration of the battery 1 according to the embodiment will be described with reference to FIG. 1.

As illustrated in FIG. 1, the battery 1 includes a power generation element 2, an outer body 5, an adhesive body 6, a positive terminal 7, a negative terminal 8, and external connection terminals 9 and 10. The battery 1 is an all-solid-state battery, for example.

The power generation element 2 is a stack including at least one battery cell. In an example illustrated in FIG. 1, the power generation element 2 includes three battery cells 21, 22, and 23 stacked in the thickness direction. The battery cells 21, 22, and 23 are electrically connected in series or parallel. Alternatively, the battery cells 21, 22, and 23 may be electrically connected to each other both in series and parallel. The battery cells 21, 22, and 23 have the same configuration, for example. The battery cell 21 will be described below as a representative.

The battery cell 21 includes a positive electrode layer, a negative electrode layer, and a solid electrolyte layer located between and in contact with the positive electrode layer and the negative electrode layer. The battery cell 21 has a structure in which the positive electrode layer, the solid electrolyte layer, and the negative electrode layer are stacked in this order.

The solid electrolyte layer includes a solid electrolyte and at least is in contact with each of a positive electrode active material layer and a negative electrode active material layer. A portion of the solid electrolyte layer may be in contact with a positive current collector and a negative current collector. For example, the positive electrode layer includes the positive current collector and the positive electrode active material layer, which is located between the positive current collector and the solid electrolyte layer. For example, the negative electrode layer includes the negative current collector and the negative electrode active material layer, which is located between the negative current collector and the solid electrolyte layer. In other words, the battery cell 21 has a structure in which the positive current collector, the positive electrode active material layer, the solid electrolyte layer, the negative electrode active material layer, and the negative current collector are stacked in this order. The positive current collector, the positive electrode active material layer, the solid electrolyte layer, the negative electrode active material layer, and the negative current collector have the same shape and the same size in plan view, but they may have different shapes and different sizes in plan view.

The positive and negative current collectors may be formed of a known material. The positive and negative current collectors each may be a foil-like, plate-like, or mesh-like current collector formed of copper, aluminum, nickel, iron, stainless steel, platinum, gold, or an alloy of two or more of these.

The positive electrode active material layer includes at least a positive electrode active material and may include at least one of a solid electrolyte, a conductive additive, and a binding agent as necessary. The binding agent may be referred to as a binder.

The positive electrode active material may be a known material that allows intercalation and deintercalation of lithium ions, sodium ions, or magnesium ions. The intercalation and deintercalation may also be referred to as insertion and extraction, or dissolution and precipitation. Examples of the positive electrode active material that allows insertion and extraction of lithium ions include a composite oxide of lithium cobalt oxide (LCO), a composite oxide of lithium nickel oxide (LNO), a composite oxide of lithium manganese oxide (LMO), a lithium-manganese-nickel composite oxide (LMNO), a lithium-manganese-cobalt composite oxide (LMCO), a lithium-nickel-cobalt composite oxide (LNCO), and a lithium-nickel-manganese-cobalt composite oxide (LNMCO).

The solid electrolyte may be a known material, such as a lithium-ion conductor, a sodium ion conductor, or a magnesium ion conductor. The solid electrolyte may be an inorganic solid electrolyte or a solid polymer electrolyte. The solid polymer electrolyte may be a gel-like solid electrolyte.

Examples of the inorganic solid electrolyte include a solid sulfide electrolyte and a solid oxide electrolyte. The solid sulfide electrolyte that can conduct lithium ions may be a compound of lithium sulfide (Li₂S) and phosphorus pentasulfide (P₂S₅). The solid sulfide electrolyte may be sulfide, such as Li₂S-SiS₂, Li₂S-B₂S₃, or Li₂S-GeS₂. Alternatively, the solid sulfide electrolyte may be sulfide including the above sulfide and an additive including at least one of Li₃N, LiCl, LiBr, Li₃PO₄, and Li₄SiO₄, for example.

Examples of the solid oxide electrolyte that can conduct lithium ions include Li₇La₃Zr₂O₁₂ (LLZ), Li_{1.3}Al_{0.3}Ti_{1.7} (PO₄)₃ (LATP), or (La, Li) TiO₃ (LLTO).

The conductive additive may be a conductive material, such as acetylene black, carbon black, graphite, or carbon fiber. The binding agent may be a binder, such as polyvinylidene fluoride.

The negative electrode active material layer includes at least a negative electrode active material and may include at least one of a solid electrolyte, a conductive additive, and a binding agent as necessary as the positive electrode active material layer.

The negative electrode active material may be a known material that allows intercalation and deintercalation of lithium ions, sodium ions, or magnesium ions. Examples of the negative electrode active material that allows insertion and extraction of lithium ions include natural graphite, artificial graphite, a carbon material, such as graphite carbon fiber and resin heat-treated carbon, metallic lithium, lithium alloy, and an oxide of lithium and a transition metal element.

The solid electrolyte layer includes at least a solid electrolyte and may include a binding agent as necessary. The solid electrolyte layer may include a solid electrolyte that conducts lithium ions.

Examples of the solid electrolyte and the binding agent include the above-listed solid electrolytes and binding agents.

In the power generation element 2, the adjacent battery cells may share the positive current collector or the negative current collector. In other words, the battery cell does not need to include the positive current collector or the negative current collector. Furthermore, a sealant including a sealing resin may cover the side surfaces of the layers of the battery cells 21, 22, and 23. The number of battery cells included in the power generation element 2 does not need to be two or more. The power generation element 2 may be composed of one battery cell.

As illustrated in FIG. 1, the power generation element 2 has an upper surface 2a, a lower surface 2b, and side surfaces 2c and 2d. The upper surface 2a and the lower surface 2b are examples of the main surfaces of the power generation element 2. The upper surface 2a and the lower surface 2b are each rectangular in plan view. The thickness of the power generation element 2 is sufficiently smaller than one side of the upper surface 2a and one side of the lower surface 2b. The power generation element 2 has a flat rectangular cuboid shape such as a plate-like shape. The upper surface 2a and the lower surface 2b may have a polygonal shape, such as a hexagonal shape and an octagonal shape, a circular shape, or an oval shape in plan view. The power generation element 2 may have a prismatic shape or a columnar shape.

The outer body 5 accommodates and encapsulates the power generation element 2. The outer body 5 covers the surface of the power generation element 2 to protect the power generation element 2 from moisture and air, for example. In this embodiment, the outer body 5 includes two lamination films 3 and 4. The lamination films 3 and 4 are attached to each other at the outer peripheral ends to encapsulate the power generation element 2. The outer body 5 may be composed of one bent lamination film.

For example, after the outer body 5 covers the power generation element 2 in reduced pressure atmosphere, the outer body 5 is exposed to the normal pressure atmosphere. This increases the pressure around the outer body 5 to atmospheric pressure, which brings the outer body 5 into close contact with the power generation element 2. Although the example illustrated in FIG. 1 has a space between the outer body 5 and the power generation element 2, the actual space is small enough to be unrecognizable.

The lamination film 3 constitutes an upper portion of the outer body 5 and covers in contact with the upper surface 2a of the power generation element 2. The lamination film 3, for example, has a three-layer structure in which a resin layer, a metal layer, and a resin layer are stacked in this order. Specifically, as illustrated in FIG. 1, the lamination film 3 includes an inner resin layer 31, a metal layer 32, and an outer resin layer 33.

The inner resin layer 31 and the outer resin layer 33 are each formed of an insulating resin material. Examples of the resin material include a polyethylene resin and a polypropylene resin. The inner resin layer 31 is in contact with the upper surface 2a of the power generation element 2.

The metal layer 32 is an example of a conductive layer having conductivity and is formed of a metal material such as aluminum. The metal layer 32 is located between and in contact with both the inner resin layer 31 and the outer resin layer 33. The metal layer 32 has a thickness of, for example, less than or equal to 1 mm, and an example of the thickness is 10 μm.

The lamination film 4 constitutes a lower portion of the outer body 5 and covers in contact with the lower surface 2b of the power generation element 2. The lamination film 4 has a three-layer structure in which a resin layer, a metal layer, and a resin layer are stacked in this order. Specifically, as illustrated in FIG. 1, the lamination film 4 includes an inner resin layer 41, a metal layer 42, and an outer resin layer 43.

The inner resin layer 41 and the outer resin layer 43 are each formed of an insulating resin material. Examples of the resin material include a polyethylene resin and a polypropylene resin. The inner resin layer 41 is in contact with the lower surface 2b of the power generation element 2.

The metal layer 42 is an example of a conductive layer having conductivity and is formed of a metal material such as aluminum. The metal layer 42 is located between and in contact with both the inner resin layer 41 and the outer resin layer 43. The metal layer 42 has a thickness of, for example, less than or equal to 1 mm, and an example of the thickness is 10 μm. The metal layer 42 is a portion of a wiring route for drawing current from the power generation element 2. Specifically, the positive terminals 7 and 8 are connected to the metal layer 42.

The inner resin layer 41 has inner openings 44 and 45. The inner openings 44 and 45 are openings through which different portions of the inner surface of the metal layer 42 are exposed. The positive terminal 7 is in contact with and electrically connected to the metal layer 42 through the inner opening 44. The negative terminal 8 is in contact with and electrically connected to the metal layer 42 through the inner opening 45.

The portion of the metal layer 42 to which the positive terminal 7 is connected and the portion of the metal layer 42 to which the negative terminal 8 is connected are electrically insulated from each other. For example, as illustrated in FIG. 1, an insulating portion 48 separates the metal layer 42. The insulating portion 48 is formed of an insulating material. The insulating portion 48 may be a portion of at least one of the inner resin layer 41 and the outer resin layer 43. This can prevent a short circuit between the positive terminal 7 and the negative terminal 8 of the power generation element 2 through the metal layer 42.

The outer resin layer 43 has outer openings 46 and 47. The outer openings 46 and 47 are openings through which different portions of the outer surface of the metal layer 42 are exposed. The external connection terminal 9 is in contact with and electrically connected to the metal layer 42 through the outer opening 46. The external connection terminal 10 is in contact with and electrically connected to the metal layer 42 through the outer opening 47.

Two inner openings 44 are arranged in the depth direction of the drawing, two inner openings 45 are arranged in the depth direction of the drawing, two outer openings 46 are arranged in the depth direction of the drawing, and two outer openings 47 are arranged in the depth direction of the drawing. However, the present disclosure should not be limited to this configuration.

The lamination films 3 and 4 each may be a known lamination film. The number of layers of each of the lamination films 3 and 4 is not limited to three and may any number suitable for the intended use. The outer body 5 that includes the lamination films 3 and 4 has high flexibility and has high barrier properties against air and moisture.

The positive terminal 7 is electrically connected to the positive electrode layers of the battery cells 21, 22, and 23. The positive electrode terminal 7 has a bent structure and is in contact with the side surface 2c and the lower surface 2b of the power generation element 2. In other words, the cross-sectional shape of the positive terminal 7 is an L-like shape. Specifically, as illustrated in FIG. 1, the positive terminal 7 has a side surface covering portion 71 and a main surface covering portion 72.

The side surface covering portion 71 covers the side surface 2c of the power generation element 2. The side surface 2c has an insulating resin, for example, to prevent the side surface covering portion 71 from coming into contact with the negative electrode layer and causing a short circuit.

The main surface covering portion 72 continuously extends from the side surface covering portion 71 and covers a portion of the lower surface 2b of the power generation element 2. The main surface covering portion 72 is in contact with and electrically connected to the metal layer 42 of the lamination film 4 through the inner opening 44.

The positive terminal 7 is formed of a conductive material such as metal. For example, the positive terminal 7 includes positive electrode tabs drawn from the battery cells 21, 22, and 23 and bound together at a portion below the power generation element 2. The bound portion corresponds to the main surface covering portion 72.

The negative terminal 8 is electrically connected to the negative electrode layers of the battery cells 21, 22, and 23. The negative terminal 8 has a bent structure and is in contact with the side surface 2d and the lower surface 2b of the power generation element 2. In other words, the cross-sectional shape of the negative terminal 8 is an L-like shape. Specifically, as illustrated in FIG. 1, the negative terminal 8 has a side surface covering portion 81 and a main surface covering portion 82.

The side surface covering portion 81 covers the side surface 2d of the power generation element 2. The side surface 2d has an insulating resin to prevent the side surface covering portion 81 from coming into contact with the positive electrode layer and causing a short circuit.

The main surface covering portion 82 continuously extends from the side surface covering portion 81 and covers a portion of the lower surface 2b of the power generation element 2. The main surface covering portion 82 is in contact with and electrically connected to the metal layer 42 of the lamination film 4 through the inner opening 45.

The negative terminal 8 is formed of a conductive material such as metal. For example, the negative terminal 8 includes negative electrode tabs drawn from the battery cells 21, 22, and 23 and bound together at a portion below the power generation element 2. The bound portion corresponds to the main surface covering portion 82.

In this embodiment, the positive terminal 7 and the negative terminal 8 are opposed to each other, but the present disclosure should not be limited to this. For example, the positive terminal 7 and the negative terminal 8 may be disposed on two side surfaces of the power generation element 2 perpendicular to each other. Alternatively, the positive terminal 7 and the negative terminal 8 may be arranged side by side to cover one side surface of the power generation element 2.

The external connection terminals 9 and 10 are terminals that connect the battery 1 to an external component. The external connection terminals 9 and 10 are formed of a conductive material, such as metal.

The external connection terminal 9 is electrically connected to the positive terminal 7. Specifically, the external connection terminal 9 is in contact with the outer surface of the metal layer 42 through the outer opening 46.

The external connection terminal 10 is electrically connected to the negative terminal 8. Specifically, the external connection terminal 10 is in contact with the outer surface of the metal layer 42 through the outer opening 47.

The external connection terminal 9 and the outer opening 46 overlap the inner opening 44 and the main surface covering portion 72 in plan view, but the present disclosure should not be limited to this. The metal layer 42, which extends to the end of the lamination film 4, can have the outer opening 46 at any position to receive the external connection terminal 9. The same holds for the external connection terminal 10 and the outer opening 47.

The adhesive body 6 is located between and in contact with both the lower surface 2b of the power generation element 2 and the outer body 5. Specifically, the adhesive body 6 is located between and in contact with both the lower surface 2b of the power generation element 2 and the upper surface 41a of the lamination film 4. The adhesive body 6 is a viscous elastic member and fixes the surfaces in contact with the adhesive body 6.

The adhesive body 6 is formed of a resin material different from the resin material forming the resin layers of the lamination films 3 and 4. For example, the adhesive body 6 contains a rubber material or a gel material. Specifically, the adhesive body 6 is formed of at least one selected from the group consisting of a fluoropolymer, such as polytetrafluoroethylene (PTFE), fluororubber, silicone rubber, butyl rubber, ethylene propylene rubber, natural rubber, chloroprene rubber, nitrile rubber, polymethyl methacrylate, urethane rubber, and polyethylene terephthalate.

The adhesive body 6 does not contain a volatile substance. The adhesive body 6 is a member already cured when the battery 1 is assembled, specifically when the power generation element 2 is encapsulated in the outer body 5. In other words, polymerization of the adhesive body 6 is finished by the time the adhesive body 6 is placed on the upper surface 41a of the lamination film 4. Thus, the adhesive body 6 does not generate gas in the encapsulating step.

The elasticity of the adhesive body 6 is constant in a service temperature range of the battery 1. Specifically, the service temperature range of the battery 1 does not include the glass transition temperature of the adhesive body 6. The service temperature range of the battery 1 is, for example, in a range of greater than or equal to −20° C. and less than or equal to 80° C.

The adhesive body 6 fills the asperities of the power generation element 2 and the asperities of the lamination film 4 and thus has the viscous surface with the maximized surface area. At atmospheric pressure before the pressure is reduced in the encapsulating step, the adhesive body 6 that is in contact with the power generation element 2 and the lamination film 4 can fix the power generation element 2 and the lamination film 4 due to viscosity of the adhesive body 6.

The adhesive body 6 has proper wettability relative to the lower surface 2b of the power generation element 2 and to the upper surface 41a of the lamination film 4. In other words, the adhesive body 6 has a low contact angle relative to each of the lower surface 2b and the upper surface 41a. The surface tension of the adhesive body 6 is smaller than that of the power generation element 2 and that of the lamination film 4. Thus, affinity for the viscous surface is high, and the adhesive body 6 exhibits a higher bonding force to the power generation element 2 and the lamination film 4.

The adhesive body 6 may have distortion resistance and a restoring force that restore the contacted portion to the original position.

In this embodiment, the adhesive body 6 is located between the positive terminal 7 and the negative terminal 8. Specifically, the adhesive body 6 is located with a gap between the positive terminal 7 and the negative terminal 8.

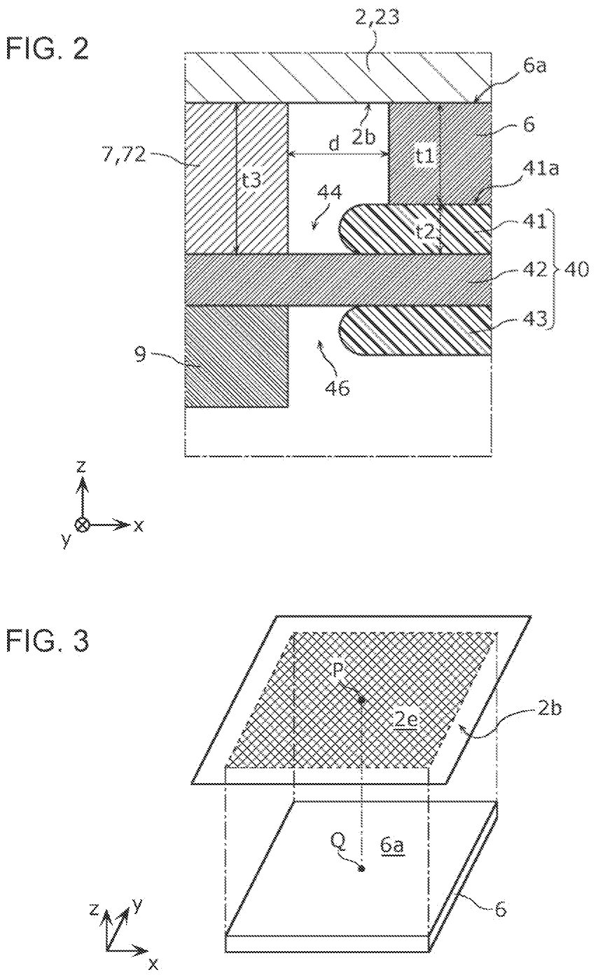

FIG. 2 is a magnified cross-sectional view of the area II in FIG. 1 including the main components. As illustrated in FIG. 2, the adhesive body 6 and the positive terminal 7 are away from each other by a distance d. For example, the adhesive body 6 and the positive terminal 7 are not in contact with each other and completely away from each other. However, only a portion of the adhesive body 6 may be in contact with the positive terminal 7. The same holds for the negative terminal 8.

The adhesive body 6 spreads outward when pressed in the thickness direction in the encapsulating step. The space between the adhesive body 6 and the positive terminal 7 and the space between the adhesive body 6 and the negative terminal 8 reduce the possibility that the adhesive body 6 will push and damage the positive terminal 7 and the negative terminal 8.

Furthermore, a total of the thickness of the adhesive body 6 and the thickness of the inner resin layer 41 is equal to each of a thickness of the portion of the positive terminal 7 in contact with the lower surface 2b and a thickness of the portion of the negative terminal 8 in contact with the lower surface 2b. Specifically, as illustrated in FIG. 2, the total of the thickness t1 of the adhesive body 6 and the thickness t2 of the inner resin layer 41 is equal to the thickness t3 of the main surface covering portion 72 of the positive terminal 7. Although not illustrated in FIG. 2, the thickness of the main surface covering portion 82 of the negative terminal 8 is equal to the thickness t3 of the main surface covering portion 72 of the positive terminal 7.

This configuration allows the positive terminal 7 and the negative terminal 8 of the power generation element 2 to be electrically connected to the metal layer 42 when the outer body 5 encapsulates the power generation element 2. Furthermore, this configuration allows the distance between the lower surface 2b of the power generation element 2 and the metal layer 42 to be kept constant, reducing the possibility that the power generation element 2 will be warped and the outer body 5 will have asperities in the outer surface.

The total of the thickness t1 and the thickness t2 may be unequal to the thickness t3 within a range not causing damage to the outer body 5 and the power generation element 2. For example, the total of the thickness t1 and the thickness t2 may be smaller than the thickness t3 or larger than the thickness t3. For example, the thickness t1 of the adhesive body 6 may be equal to the thickness t3 of the main surface covering portion 72. The thickness t1 of the adhesive body 6 may be larger than the thickness t3 of the main surface covering portion 72 or smaller than the thickness t3.

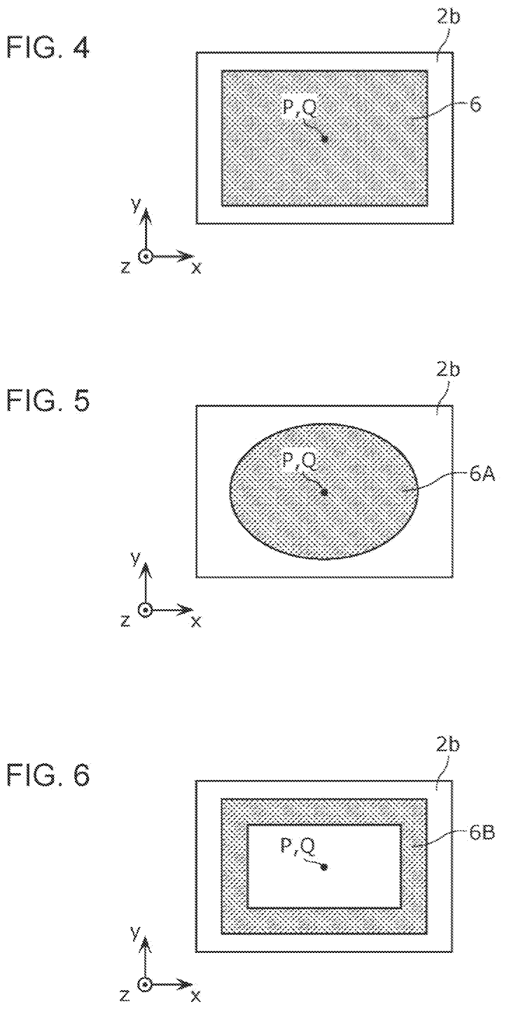

FIG. 3 is a perspective view and FIG. 4 is a plan view each illustrating the lower surface 2b of the power generation element 2 and the upper surface 6a of the adhesive body 6 of the battery 1 according to the present embodiment to indicate the shapes of them and the positional relationship between them.

As illustrated in FIGS. 3 and 4, the adhesive body 6 overlaps the center P of the lower surface 2b of the power generation element 2 in plan view. Specifically, the center Q of the adhesive body 6 coincides with the center P of the lower surface 2b. The center P and the center Q each coincides with the center of gravity of the surface. The lower surface 2b and the upper surface 6a are rectangular in plan view, and thus the centers P and Q are intersections of the diagonal lines.

Here, the term “coincide” means not only “perfectly coincide” but also “substantially coincide.” In other words, “minor misalignment” is included in “coincide”. Specifically, the term “coincide” means that the distance between the center P and the center Q in plan view is less than or equal to 10% of the length of one side of the adhesive body 6 or the power generation element 2.

In this embodiment, the attachment area between the adhesive body 6 and the lower surface 2b of the power generation element 2 is greater than or equal to 10% and less than 100% of the area of the lower surface 2b. In FIG. 3, an attachment surface 2e is shaded. The adhesive body 6 is smaller than the lower surface 2b in plan view, and the attachment surface 2e coincides with the upper surface 6a of the adhesive body 6. The adhesive body 6 is more likely to prevent displacement as the attachment area increases. Thus, the attachment area may be greater than or equal to 30% of the area of the lower surface 2b, greater than or equal to 50%, greater than or equal to 70%, or greater than or equal to 90%. The same holds for the attachment area between the adhesive body 6 and the upper surface 41a of the lamination film 4. The attachment surface of the lower surface 2b of the power generation element 2 and the attachment surface of the upper surface 41a of the lamination film 4 may be similar in shape.

As illustrated in FIG. 4, the adhesive body 6 has a point symmetrical shape, a line symmetrical shape, or a rotationally symmetrical shape in plan view. For example, the adhesive body 6 that is rectangular in plan view is point symmetric and rotationally symmetric about the center Q. The adhesive body 6 is also line symmetric about an axis extending along the x axis or the y axis through the center Q. Here, a rectangle includes an oblong and a square.

The shape of the adhesive body 6 is not limited to the rectangle. FIGS. 5 and 6 are plan views each illustrating the lower surface 2b of the power generation element 2 of the battery 1 according to this embodiment and an upper surface of an adhesive body according to a modification to indicate the shapes of them and the positional relationship between them.

The battery 1 may include an adhesive body 6A having an oval shape in plan view as illustrated in FIG. 5, instead of the adhesive body 6. The center Q of the adhesive body 6A is an intersection between the major axis and the minor axis of the oval. Alternatively, the adhesive body 6A may have a circular shape in plan view.

The battery 1 may include an adhesive body 6B having a rectangular ring shape in plan view as illustrated in FIG. 6, instead of the adhesive body 6. The center Q of the adhesive body 6B coincides with the center of gravity of the rectangular ring. The adhesive body 6B in plan view may have another polygonal ring shape, such as a hexagonal ring shape, a circular ring shape, or an oval ring shape. Furthermore, the battery 1 may further include a small adhesive body 6 inside the adhesive body 6B. In other words, the adhesive body of the battery 1 may include multiple separated island portions.

As described above, the adhesive bodies 6, 6A, and 6B each have a shape less unevenly elongated from the center Q to one side. In other words, the adhesive bodies 6, 6A, and 6B have an isotropic shape. This reduces asymmetricity in shape of the attachment surface between the adhesive body 6, 6A, or 6B and the power generation element 2, and thus direction dependency of the anti-displacement effect caused by the adhesive body 6, 6A, or 6B can be reduced. This further reduces displacement of the power generation element 2.

The adhesive body 6 is viscous but not adhesive. The same holds for the adhesive bodies 6A and 6B. The following describes difference between viscous and adhesive.

The adhesive body 6, which is viscous, exhibits an anchor effect (fastener effect) to fix the power generation element 2 and the lamination film 4 to each other. The anchor effect occurs when a portion of the adhesive body 6 cures after filling the micro asperities in the surfaces. The adhesive body 6 fills the asperities by weak capillary action of gel. An adhesive also exhibits the anchor effect. However, an anchor effect of the adhesive is strong because capillary action of a liquid adhesive is strong, and thus the anchor effect of the adhesive is stronger than that of the adhesive body 6. This does not allow the adhesive to readily detach.

The adhesive forms a stronger bond due to an electrostatic effect, chemical bonding, and mutual diffusion, in addition to the anchor effect. The bond resulting from an electrostatic effect is due to an electrostatic force generated between an adhesive and an adherend. The bond resulting from the chemical bonding is due to chemical bonding between molecules of an adhesive and an adherend at the interface. Common epoxy curable adhesives use the chemical bonding. The mutual diffusion forms a bond when molecules of the adhesive and the dissolved surface of an adherend are entangled and cured. A volatile adhesive including a solvent as a main component uses the mutual diffusion.

As described above, the adhesive has a bonding function using the strong anchor effect, the electrostatic effect, the chemical bonding, and the mutual diffusion and forms a strong bond to an adherend. Thus, when an adhesive is used to attach the power generation element 2 to the lamination film 4, it is almost impossible to detach the adhesive without damage to the power generation element 2.

In contrast, the adhesive body 6 forms a bond by using a weak anchor effect and does not have a bonding function using the strong anchor effect, the electrostatic effect, the chemical bonding, and the mutual diffusion. Thus, the adhesive body 6 is readily detachable while having a certain fixing function.

The term “readily” means that the adhesive body 6 is detached without damage to the power generation element 2. Specifically, the peel strength between the adhesive body 6 and the power generation element 2 is smaller than the peel strength between the layers of the power generation element 2. Furthermore, the peel strength between the adhesive body 6 and the lamination film 4 is smaller than the peel strength between the layers of the power generation element 2.

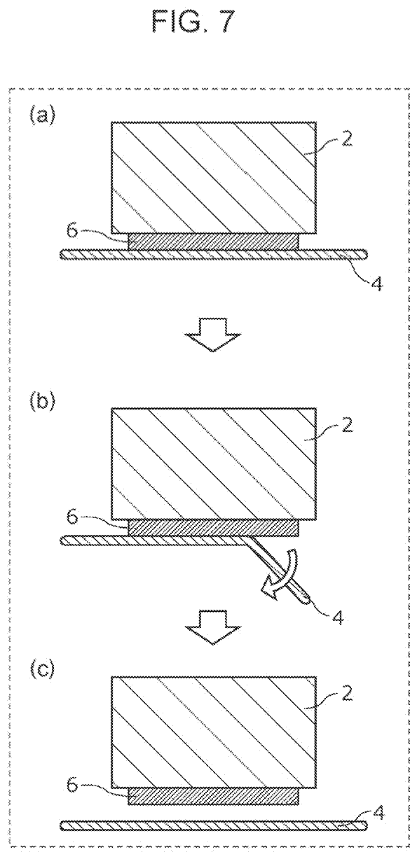

FIG. 7 is a view schematically illustrating how the outer body 5 is detached from the adhesive body 6 in the battery 1 according to the present embodiment. As illustrated in FIG. 7, the lamination film 4 can be readily detached because the peel strength between the adhesive body 6 and the lamination film 4 is smaller than the peel strength between the layers of the power generation element 2.

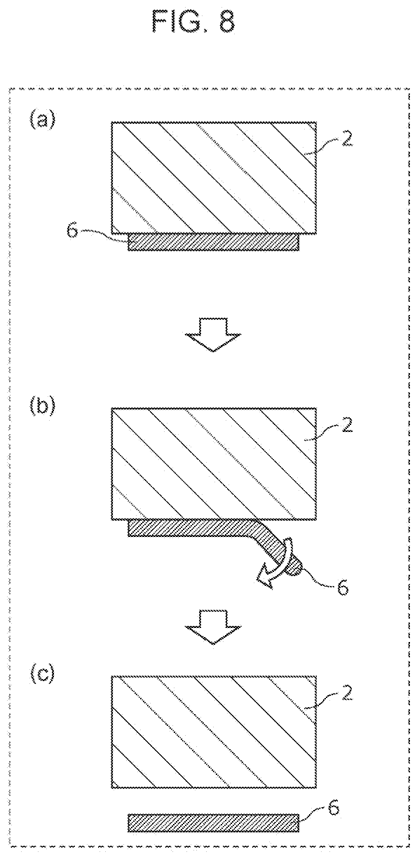

FIG. 8 is a view schematically illustrating how the adhesive body 6 is detached from the power generation element 2 in the battery 1 according to the present embodiment. As illustrated in FIG. 8, the adhesive body 6 can be readily detached because the peel strength between the adhesive body 6 and the power generation element 2 is smaller than the peel strength between the layers of the power generation element 2.

The detached adhesive body 6 can be used to reduce displacement between another power generation element 2 and another lamination film 4. In other words, the adhesive body 6 is reusable.

### 3. Production Method

Next, a method of producing the battery 1 according to the present embodiment will be described. The method of producing the battery 1 described below is an example, and the method of producing the battery 1 should not be limited to the example.

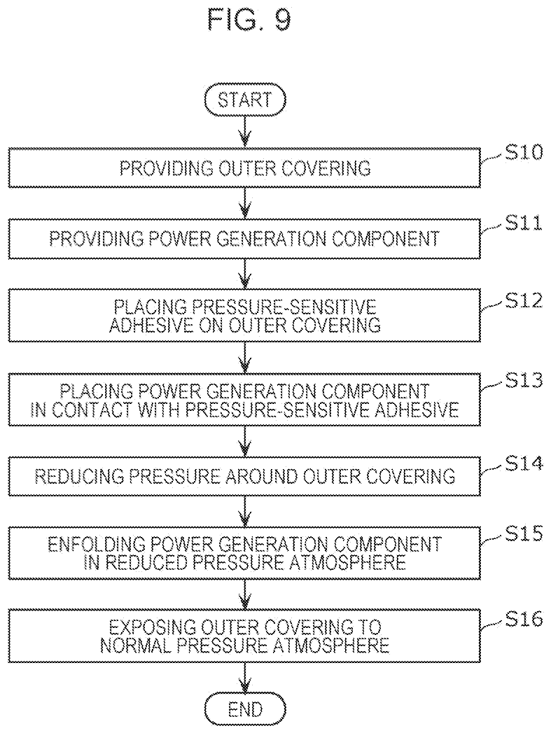

FIG. 9 is a flow chart indicating the method of producing the battery 1 according to the present embodiment.

First, as indicated in FIG. 9, the outer body 5 is provided (S10). Specifically, the lamination films 3 and 4 included in the outer body 5 are provided. More specifically, the lamination films 3 and 4 each having a three-layer structure in which a resin layer, an aluminum layer, and a resin layer are stacked on top of another in this order are provided in a lower pressure chamber.

Next, the power generation element 2 including stacked battery cells 21, 22, and 23 is provided (S11). The battery cells 21, 22, and 23 are each produced by, for example, a known method in which a positive electrode active material, a solid electrolyte, and a negative electrode active material are laminated on a current collector, for example, by coating. The battery cells 21, 22, and 23 are stacked and connected in series or parallel to form the power generation element 2. The step of providing the power generation element 2 (S11) may be performed before or concurrently with the step of providing the outer body 5 (S10).

Next, the adhesive body 6 is placed on the outer body 5 (S12). Specifically, the adhesive body 6 is placed on the lamination film 4 in an area not having the inner openings 44 and 45. At this time, the adhesive body 6 is brought into contact with and fixed to the upper surface 41a of the lamination film 4 by pressing or applying pressure to the upper surface of the adhesive body 6. The pressing or the applying pressure at the step of placing the adhesive body 6 (S12) is optional. Furthermore, the adhesive body 6 used at this step may be an adhesive body that has been detached from another lamination film as illustrated in FIG. 8. In other words, the adhesive body 6 may be an adhesive body that was used at least one time.

Next, the power generation element 2 having the positive terminal 7 and the negative terminal 8 is placed on the upper surface 6a of the adhesive body 6 (S13). At this time, the power generation element 2 is placed such that the inner openings 44 and 45 in the lamination film 4 overlap the positive terminal 7 and the negative terminal 8, respectively. The upper surface 6a of the adhesive body 6 on the lamination film 4 and the lower surface 2b of the power generation element 2 are brought into close contact with each other by pressing or applying pressure to the entire power generation element 2 in this state. This fixes the adhesive body 6 and the lamination film 4 to each other, preventing easy displacement. The pressing or applying pressure at the step of placing the power generation element 2 (S13) is optional.

Next, the pressure around the outer body 5 is reduced (S14). Specifically, the lamination film 3 is disposed to cover the upper surface 2a of the power generation element 2, and the pressure around the lamination films 3 and 4, in other words, the pressure in the lower pressure chamber is reduced. Then, the power generation element 2 is enfolded by the lamination films 3 and 4 in the reduced pressure atmosphere (S15). Specifically, the lamination film 3 and the lamination film 4 are attached to each other at the outer peripheral ends. For example, all the outer peripheral ends of the lamination films 3 and 4 except for some portions are bonded by thermocompression to form the outer body 5, which is a pouch-like lamination film. In the lower pressure chamber, the pressure in the outer body 5 enclosing the power generation element 2 is reduced, and the uncompressed portions are subjected to thermocompression under the reduced pressure such that the outer body 5 encapsulates the power generation element 2. The step of reducing the pressure around the lamination films 3 and 4 (S14) may include pressing or applying pressure to the power generation element 2 and the adhesive body 6.

After the encapsulating, the lamination films 3 and 4, or the outer body 5, are exposed to the normal pressure atmosphere (S16). Specifically, the pressure in the lower pressure chamber is increased to the atmospheric pressure. This brings the outer body 5 to be into close contact with the power generation element 2 due to an external force generated by, for example, the airflow and the atmospheric pressure. Without the adhesive body 6, the power generation element 2 may be moved by the external force and displaced. The battery 1 according to the present embodiment includes the adhesive body 6 that fixes the power generation element 2 and the lamination film 4 to each other. Thus, the power generation element 2 is less likely to be moved by the external forces, and displacement is less likely to occur. The adhesive body 6 is not an adhesive and does not contain a volatile substance. This reduces deterioration of the performance of the power generation element 2 resulting from a volatile substance of an adhesive and damage and detachment of the adhesive body 6 caused by deformation of the power generation element 2. The step of exposing the outer body 5 to the normal pressure atmosphere (S16) may include pressing or applying pressure to the power generation element 2 and the adhesive body 6.

### Other Embodiments

The battery and the method of producing the battery according to one or more aspects of the present disclosure were described above with reference to the embodiments, but the present disclosure should not be limited to the embodiments. Without departing from the gist of the present disclosure, various changes may be added to the embodiments by a person skilled in the art, and the components in different embodiments may be combined. They are construed as being within the scope of the present disclosure.

For example, the peel strength between the adhesive body and each of the power generation element 2 and the lamination film 4 may be equal to or larger than the peel strength between the layers of the power generation element 2. The adhesive body 6 may be non-reusable.

Furthermore, the shape of the adhesive body in plan view is not limited to isotropic but may be anisotropic. The adhesive body may be larger than the power generation element 2 in plan view.

Furthermore, the adhesive body may be located between and in contact with the upper surface 2a of the power generation element 2 and the lamination film 3. In other words, the adhesive body does not need to be located between the positive terminal 7 and the negative terminal 8.

Furthermore, in the example, the lamination film 4 includes all the inner openings 44 and 45 and the outer openings 46 and 47, but the present disclosure should not be limited to this example. For example, the lamination film 3 may include the inner opening 44 and the outer opening 46 or the inner opening 45 and the outer opening 47. In other words, one of the external connection terminals 9 and 10 may be electrically connected to the power generation element 2 through the lamination film 3, and the other of the external connection terminals 9 and 10 may be electrically connected to the power generation element 2 through the lamination film 4.

Other various modifications, substitutions, additions, or omissions may be performed on the embodiments within or equivalent to the scope of the claims.

The present disclosure can be used as a highly reliable battery and can be used as an in-car battery or a battery installed in various electrical devices.

What is claimed is:

1. A battery comprising:
a power generation element including a positive electrode layer, a negative electrode layer, and a solid electrolyte layer located between and in contact with both the positive electrode layer and the negative electrode layer;
an outer body accommodating the power generation element; and
an adhesive body located between and in contact with both a main surface of the power generation element and the outer body.

2. The battery according to claim 1, wherein a peel strength between the adhesive body and the power generation element is smaller than a peel strength between the layers of the power generation element.

3. The battery according to claim 1, wherein a peel strength between the adhesive body and the outer body is smaller than a peel strength between the layers of the power generation element.

4. The battery according to claim 1, wherein the adhesive body overlaps a center of the main surface when the main surface is viewed in plan view.

5. The battery according to claim 1, wherein a center of the adhesive body coincides with a center of the main surface when the main surface is viewed in plan view.

6. The battery according to claim 1, wherein the adhesive body has a point symmetrical shape, a line symmetrical shape, or a rotationally symmetrical shape when the main surface is viewed in plan view.

7. The battery according to claim 1, wherein a contact area between the adhesive body and the main surface is greater than or equal to 10% and less than 100% of an area of the main surface.

8. The battery according to claim 1, further comprising:
a positive terminal electrically connected to the positive electrode layer; and
a negative terminal electrically connected to the negative electrode layer, wherein
each of the positive terminal and the negative terminal has a bent structure which is in contact with a side surface of the power generation element and the main surface, and
the adhesive body is located with a gap between the positive terminal and the negative terminal.

9. The battery according to claim 8, wherein the outer body includes a resin layer in contact with the adhesive body, and
a total of a thickness of the adhesive body and a thickness of the resin layer is equal to each of a thickness of a portion of the positive terminal in contact with the main surface and a thickness of a portion of the negative terminal in contact with the main surface.

10. The battery according to claim 1, wherein the adhesive body includes a rubber material or a gel material.

11. The battery according to claim 1, wherein the adhesive body is formed of at least one selected from the group consisting of a fluoropolymer, fluororubber, silicone rubber, butyl rubber, ethylene propylene rubber, natural rubber, chloroprene rubber, nitrile rubber, polymethyl methacrylate, urethane rubber, and polyethylene terephthalate.

12. The battery according to claim 1, wherein the outer body includes a lamination film.

13. The battery according to claim 1, wherein the solid electrolyte layer is a solid electrolyte layer that conducts lithium ions.

14. A method of producing a battery comprising:
providing an outer body;
providing a power generation element;
placing an adhesive body on the outer body;
placing the power generation element to be in contact with the adhesive body;
reducing pressure around the outer body;
enfolding the power generation element in the outer body in the reduced pressure atmosphere; and
exposing the outer body to a normal pressure atmosphere.

15. The method of producing a battery according to claim 14, wherein the placing the power generation element to be in contact with the adhesive body further comprises pressing or applying pressure to the power generation element and the adhesive body.

16. The method of producing a battery according to claim 14, wherein the reducing the pressure around the outer body comprises pressing or applying pressure to the power generation element and the adhesive body.

17. The method of producing a battery according to claim 14, wherein the exposing the outer body to a normal pressure atmosphere comprises pressing or applying pressure to the power generation element and the adhesive body.

18. The method of producing a battery according to claim 14, wherein the outer body includes a lamination film.

19. The method of producing a battery according to claim 14, further comprising detaching the adhesive body from the outer body; and
placing the detached adhesive body onto an outer body different from the outer body.

20. A method of producing a battery comprising:
detaching the adhesive body from the outer body of the battery according to claim 1; and
placing the detached adhesive body onto an outer body different from the outer body.
